(19) United States
(12) Patent Application Publication
(10) Pub. No.: US 2004/0059612 A1
(43) Pub. Date: Mar. 25, 2004

(54) Method of planning and computer product

(75) Inventors: Atsushi Sakurai, Kawasaki (JP); Toru Suzuki, Nagoya (JP); Hirotaka Ito, Nagoya (JP); Takaaki Yamazaki, Nagoya (JP); Masahiro Ueda, Nagoya (JP); Kenji Kuwabara, Nagoya (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/671,595

(22) Filed: Sep. 29, 2003

Related U.S. Application Data
(63) Continuation of application No. PCT/JP02/03194, filed on Mar. 29, 2002.

(30) Foreign Application Priority Data
Mar. 30, 2001 (JP) 2001-101474

(51) Int. Cl. G06F 17/60

(52) U.S. Cl. 705/7

(57) ABSTRACT

A method of planning, a computer program, and a computer product for realizing supply-demand planning in a supply chain make a computer execute fetching switching information corresponding to a base and an item from a table, which contains the switching information corresponding to the base and the item, and performing, depending upon the switching information, either of supply-demand planning per order and supply-demand planning based on total amount of orders.

### TECHNICAL FIELD

This invention relates to a method of making a supply-demand plan at each base in a supply chain.

### BACKGROUND ART

Conventionally, in assembly and process industries, a supply-demand balance and a stock balance are planned by taking a procurement-driven system in which a planning is made per order, and in a manufacturing industry, the supply-demand balance and the stock balance are planned by taking a manufacturing-driven system based on a total amount of demand.

With the former planning method, it is possible to handle an inquiry about a delivery date or the like for each order from clients. However, at a manufacturing factory, products may be manufactured unnecessarily more than needed, and as a result, a manufacturing efficiency becomes low.

On the other hand, with the latter planning method based on the total amount of demand, although it is possible to make a plan with an appropriate manufacturing amount, a disadvantage is that an order-basis handling is not possible.

Consequently, applying only one of the above methods may not fulfill business requirements, and may cause inconveniences.

### DISCLOSURE OF THE INVENTION

It is an object of the present invention to solve at least the problems in the conventional technology.

The computer program for realizing supply-demand planning in a supply chain according to one aspect of the present invention makes a computer execute fetching switching information corresponding to a base and an item from a table, which contains the switching information corresponding to the base and the item, and performing, depending upon the switching information, either of supply-demand planning per order and supply-demand planning based on total amount of orders.

The method of a supply-demand planning in a supply chain according to another aspect of the present invention includes creating a table containing switching information corresponding to a base and an item, fetching the switching information corresponding to the base and the item from the table, and performing, depending upon the switching information, either of supply-demand planning per order and supply-demand planning based on total amount of orders.

The computer-readable recording medium according to still another aspect of the present invention stores a computer program for realizing supply-demand planning in a supply chain, which makes a computer execute fetching switching information corresponding to a base and an item from a table, which contains the switching information corresponding to the base and the item, and performing, depending upon the switching information, either of supply-demand planning per order and supply-demand planning based on total amount of orders.

The computer program for making supply-demand planning for each base in a supply chain in which a plurality of bases are cascaded according to still another aspect of the present invention makes a computer execute processing a procurement-driven planning in which the supply-demand planning is made for a plurality of bases associated with an order unit, processing a manufacturing-driven planning in which the supply-demand planning is made based on a total amount of orders for a specific base, and making the supply-demand planning for the whole supply chain by using either of the procurement-driven planning and the manufacturing-driven planning based on switching information that is managed associated with a combination of a base and an item.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a schematic diagram of a system according to the present invention;

FIG. 2 is a flow chart for explaining operations of the system;

FIG. 3 illustrates an information table for the system;

FIG. 4 illustrates an example of a supply chain according to the present invention;

FIG. 5A and FIG. 5B are schematic diagrams of a procurement-driven system according to the present invention; and

FIG. 6A and FIG. 6B are schematic diagrams of a manufacturing-driven system according to the present invention.

### BEST MODE FOR CARRYING OUT THE INVENTION

Exemplary embodiments of a method of planning, a computer program, and a computer product according to the present invention are explained in detail with reference to the accompanying drawings.

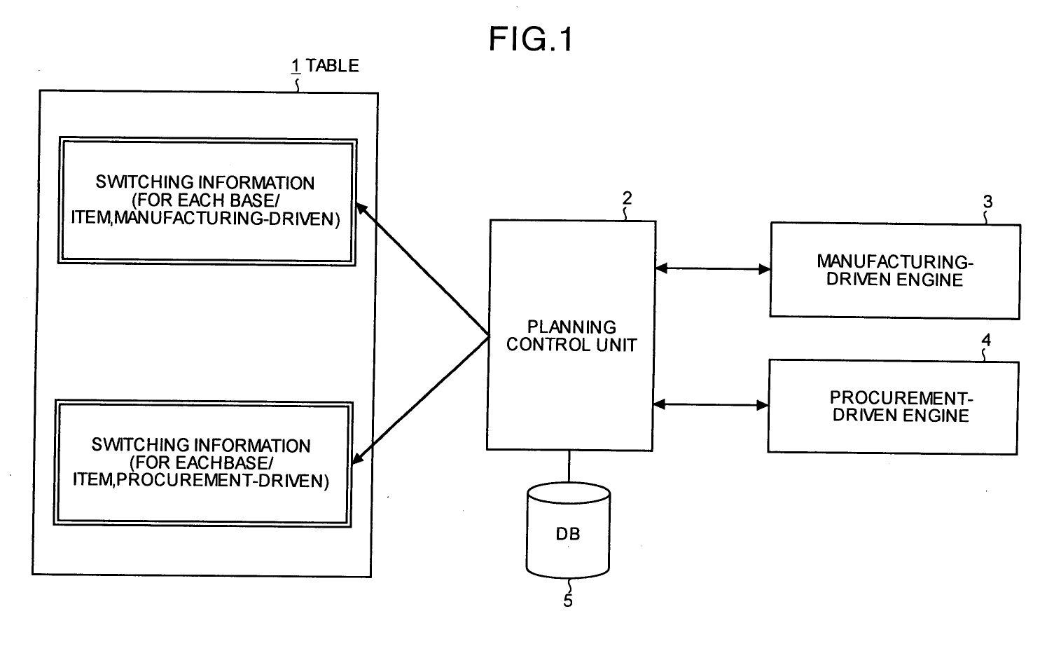

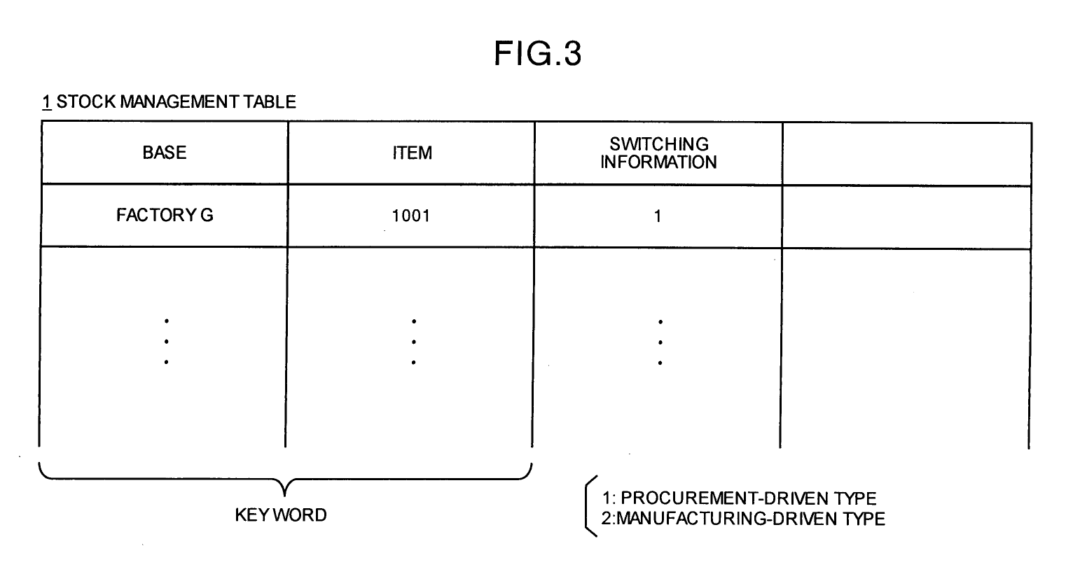

FIG. 1 is a schematic diagram of a system according to the present invention. A table 1 contains a switching information corresponding to a base in a supply chain and an item, for example, the switching information in a stock management table 1 shown in FIG. 3 (e.g., 1 denotes a procurement-driven system and 2 denotes a manufacturing-driven system).

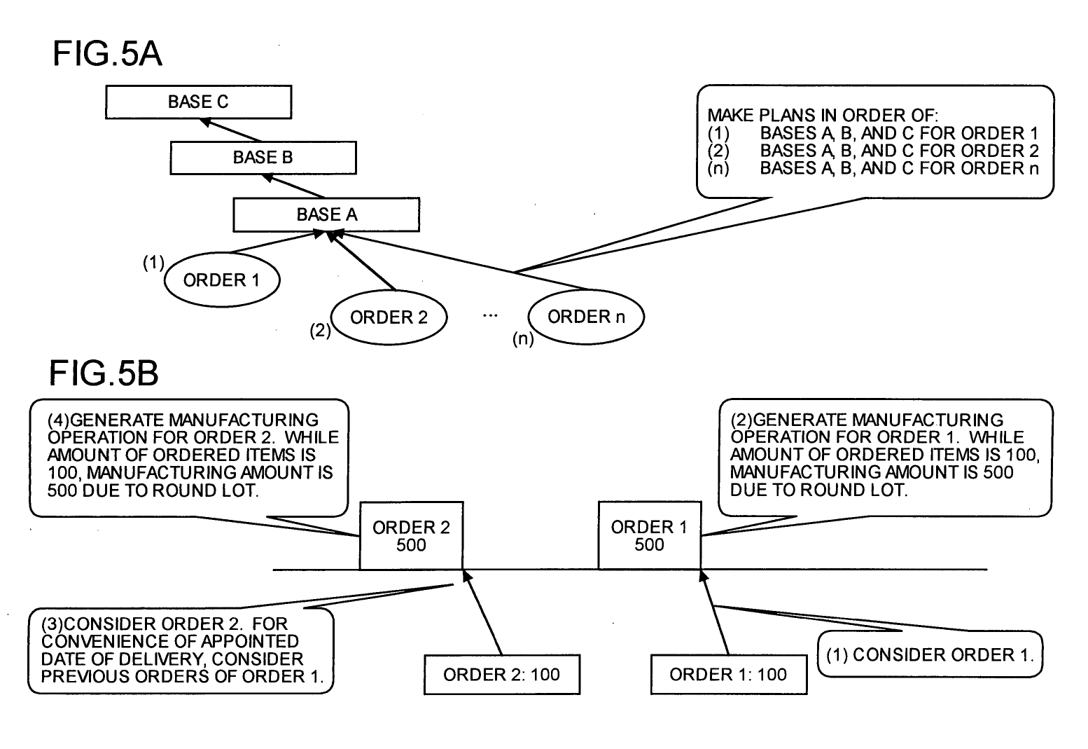

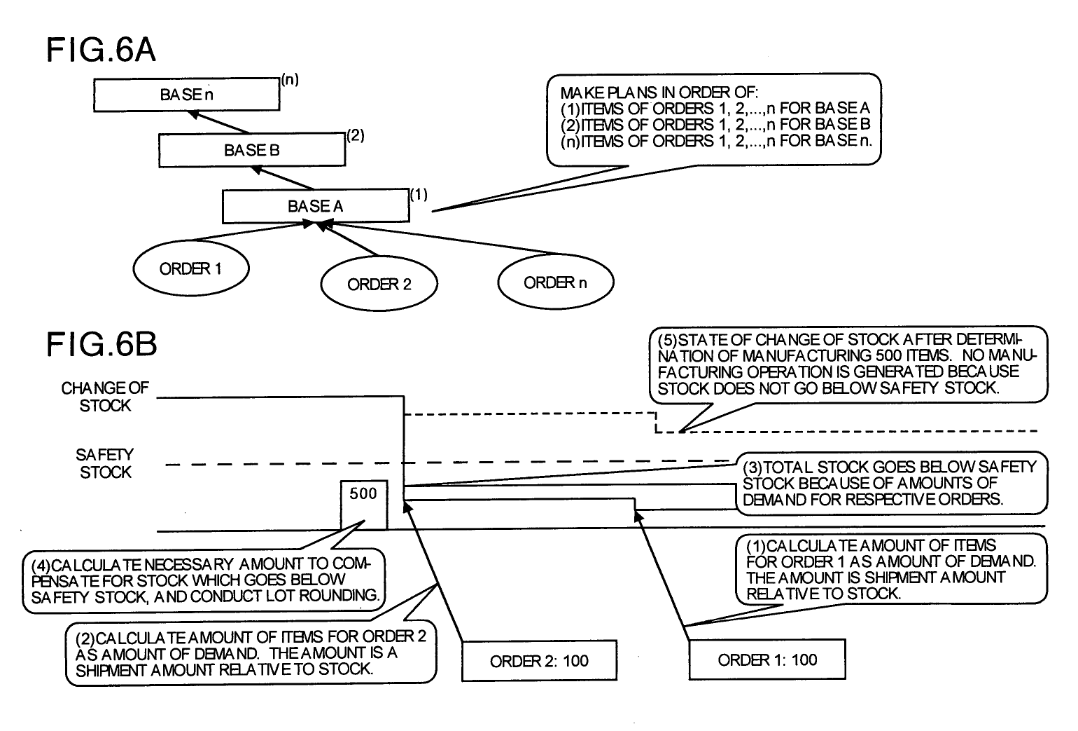

A planning control unit 2 makes a plan (a plan of the procurement-driven system (see FIG. 5) or a plan of the manufacturing-driven system (see FIG. 6)) based on the information in the table 1.

A manufacturing-driven engine 3 is an engine for making a plan by manufacturing-driven system (see FIG. 6). A procurement-driven engine 4 is an engine for making a plan by procurement-driven system (see FIG. 5). A DB (database) 5 stores various types of data. In the present embodiment, the DB 5 stores bases, items, etc. in a supply chain.

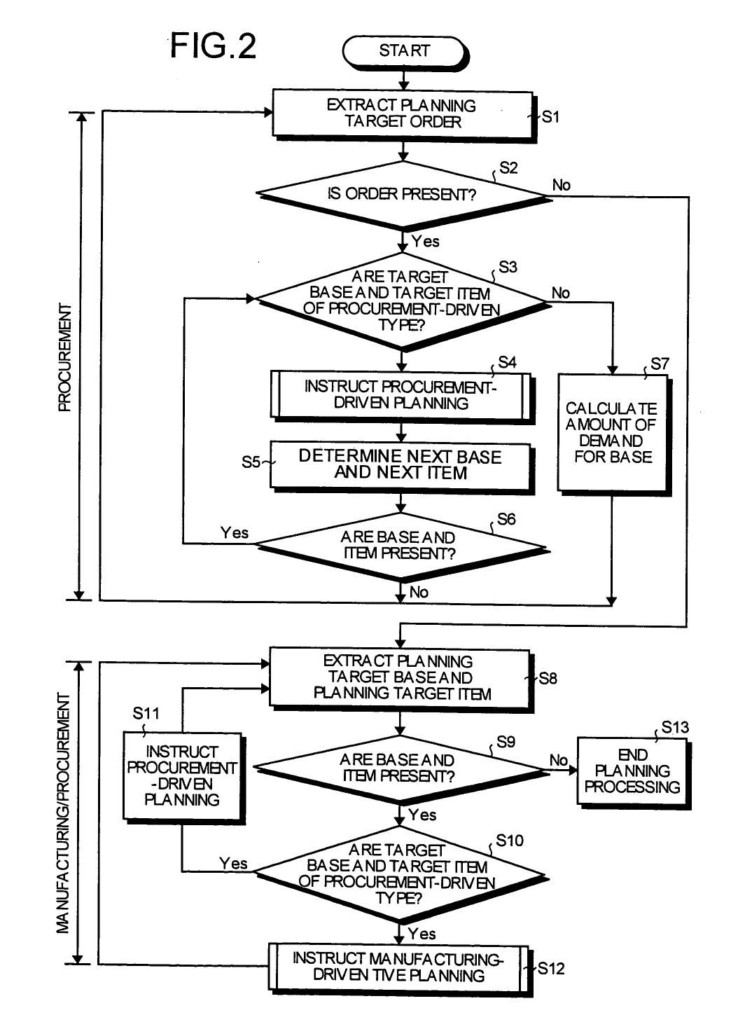

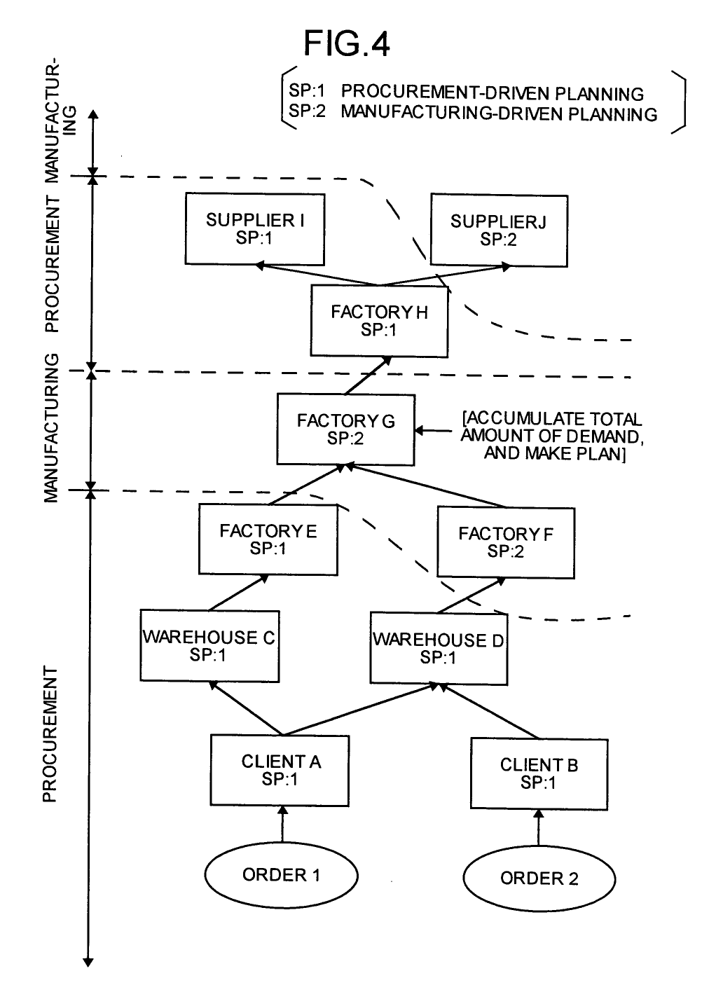

A planning (procurement-driven planning, manufacturing-driven planning, and switching between them) in the supply chain shown in FIG. 4 will be explained in detail based on a flow chart shown in FIG. 2. An upper part shown in FIG. 4 indicates the procurement-driven planning, a lower right part indicates the manufacturing-driven planning, and a lower left part indicates the procurement-driven planning.

FIG. 2 is the flowchart for explaining operations of the system according to the present invention. A planning target order is extracted at a step S1. At this step, an order 1 from a client A is extracted at, for example, a base “warehouse C” shown in FIG. 4.

At a step S2, an existence of the order is identified. If a result of the step S2 is YES, the order is extracted, so that a processing goes to a step S3. If the result is NO, it means the order extraction is finished, so that the processing goes to a step S8.

At the step S3, it is determined whether the target base and the target item are procurement-driven types based on a switching information in the stock management table 1 shown in FIG. 3 using the base and the item as key words (if the switching information is 1, the planning is of the procurement-driven type, and if the switching information is 2, the planning is of the manufacturing-driven type). If a result of the step S3 is YES, the planning type is determined as the procurement-driven type and the processing goes to a step S4. If the result is NO, the planning type is determined as the manufacturing-driven type and the processing goes to a step S7.

When the planning type is determined as the procurement-driven type based on the base and the item by the determination result the step S3, a procurement-driven planning is instructed (the planning is instructed to the procurement-driven engine 4 shown in FIG. 1) at the step S4 and the processing goes to a step S5.

At the step S5, a next base and a next item are identified.

At a step S6, it is determined whether the base and the item are present. If a result of the step S6 is YES, the processing returns to the step S3 and the following steps are repeated. If the result is NO, the processing returns to the step S1 and the following steps are repeated.

When the planning type is determined as the manufacturing-driven type based on the base and the item by the result of the step S3, an amount of demand are calculated for the base (since the procurement-driven planning is switched to the manufacturing-driven planning, amounts of demand for all plans by the procurement-driven are summed up) at the step S7 and the processing returns to the step S1 to repeat the following steps. As a result, at the base where the procurement-driven planning is switched to the manufacturing-driven planning, e.g., the base “factory G” shown in FIG. 4, total amounts of demand for all the procurement-driven plans are accumulated and then a manufacturing-driven plan is initiated.

Through the steps S1 to S7, all procurement-driven plans can be instructed for the procurement-driven order determined based on the base and the item, and total amounts of demand for all manufacturing-driven bases is calculated.

At the step S8, a planning target base and a planning target item are extracted. Since orders based on the procurement-driven bases and items are all completed as the result of NO at the step S2, the planning target base and the planning target item of the manufacturing-driven type switched from the procurement-driven type are extracted.

At a step S9, it is determined whether a base and an item are present. If a result of the step S9 is YES, the processing goes to a step S10. If the result is NO, this means that planning is completed for all the bases and items, so that the planning processing is finished at a step S13.

At the step S10, it is determined whether the target base and the target item are of the procurement-driven type. The stock management table 1 shown in FIG. 3 is referred to for the base and the item extracted at the step S8 to determine whether the switching information on the base and the item is 1 (procurement-driven system). If a result of the step S10 is YES, the switching information is determined as the procurement-driven system. A procurement-driven planning is instructed at a step S11 and the processing returns to the step S8 to repeat the following steps. If the result is NO, the switching information is determined as the manufacturing-driven system. A manufacturing-driven planning is instructed at a step S12, and the processing returns to the step S8 to repeat the following steps.

Through the steps S8 to S13, the base and the item are extracted, and either the procurement-driven planning or the manufacturing-driven planning is instructed based on the switching information referring to the stock management table shown in FIG. 3. At this time, at the base where the procurement-driven planning is switched to the manufacturing-driven planning, all amounts of demand for the base are obtained, and then the manufacturing-driven planning is initiated, thereby improving manufacturing efficiency.

FIG. 3 illustrates an example of the information table according to the present invention. The table is a stock management table that contains following types of information.

Base:

Item:

Switching information: 1 indicates the procurement-driven system, and 2 indicates the manufacturing-driven system.

In the table shown in FIG. 3, a base and an item are used as key words for searching.

By registering the switching information using the base and the item as key words, it is possible to arbitrarily set the planning type so as to be able to make an optimum plan based on the switching information (for planning by the procurement-driven or by the manufacturing-driven) correspond to each base (e.g., a warehouse C, a factory E, etc.) and an item.

FIG. 4 illustrates an example of a supply chain according to the present invention. In the supply chain shown in the figure, each order flows in a direction of an arrow. A left end of the supply chain indicates a range of each of the procurement-driven system and the manufacturing-driven system. At each base, SP:1 denotes the procurement-driven planning and SP:2 denotes the manufacturing-driven planning. At bases where the planning is switched from the procurement-driven system to the manufacturing-driven system, e.g., bases “factory F” and “factory G”, total amounts of demand from lower level bases are accumulated and then planning (planning by the manufacturing-driven system) is, initiated. If the planning is switched from the manufacturing-driven system to the procurement-driven system, it is not necessary to accumulate the amounts of demand and planning may be started at an appropriate time.

In the supply chain, it is possible to arbitrarily set planning so as to execute an optimum planning by setting the switching information (setting the switching information using the base and the item shown in the stock management table 1 of FIG. 3 as key words).

FIG. 5A and FIG. 5B are schematic diagrams of a procurement-driven system according to the present invention.

FIG. 5A illustrates an example of the supply chain at procurement-driven bases. The supply chain in which orders 1, 2, . . . and n (where n is a positive integer) are present at a base A, the orders are placed from the base A to a base B, and the orders are then placed from the base B to a base C. In this procurement-driven planning:

(1) Plans are made in order of the base A, the base B, and the base C for each item of the order 1;

(2) Plans are made in order of the base A, the base B, and the base C for each item of the order 2;

(n) Plans are made in order of the base A, the base B, and the base C for each item of the order n.

FIG. 5B illustrates an example of making plans for the order 1 and the order 2 at one base by the procurement-driven system, wherein

(1) the order 1 is taken into consideration,

(2) a manufacturing operation is generated for the order 1 (Although an amount of the ordered item is 100, a manufacturing amount is 500 as indicated by an arrow due to a round lot.),

(3) the order 2 is taken into consideration (For a convenience of a delivery date, prior orders to the order 1 are considered.), and

(4) a manufacturing operation is generated for the order 2 (Although an amount of the ordered item is 100, a manufacturing amount is 500 as indicated by an arrow due to the round lot.).

As described above, if plans are made by the procurement-driven system, a manufacturing plan and the like are made for each order, and the delivery date of each order is made clear. However, an unnecessary amount of an item is likely to be manufactured due to the round lot for the convenience of the delivery date or the like.

FIG. 6A and FIG. 6B are schematic diagrams of a manufacturing-driven system according to the present invention. FIG. 6A illustrates an example of the supply chain at manufacturing-driven bases. FIG. 6B illustrates an example of the supply chain in which orders 1, 2, . . . and n (where n is a positive integer) are present at a base A, the orders are placed from the base A to a base B, and the orders are then placed from the base B to a base C. In this manufacturing-driven planning:

(1) Plans are made for each item of the order 1, the order 2, and the order 3 for the base A.

(2) Plans are made for each item of the order 1, the order 2, and the order 3 for the base B.

(n) Plans are made for each item of the order 1, the order 2, and the order 3 for the base n.

FIG. 6B illustrates an example of making plans for the order 1 and the order 2 at one base by the manufacturing-driven system, wherein

(1) an amount of items for the order 1 is calculated as an amount of demand (the amount is a shipment amount relative to a stock. As indicated by an arrow, the stock is decreased by as much as the amount of items for the order 1 “100”;

(2) an amount of items for the order 2 is calculated as an amount of demand (the amount is the shipment amount relative to the stock, As indicated by an arrow, the stock is decreased by as much as the amount of items for the order 2 “100”;

(3) total stock goes below safety stock because of amounts of demand for the respective orders.

(4) a necessary amount to compensate for the stock which goes below the safety stock level is calculated, a lot rounding is conducted, a manufacturing, (the amount is set as 500, and manufacturing of 500 items is planned.), and

(5), a state of the change of the stock after the determination of manufacturing 500 items is indicated by a dotted line. In this state, it is seen that the stock does not go below the safety stock.

As explained, to do manufacturing-driven planning, plans are made in order of, for example, order 1, order 2, and the like for each base to determine a manufacturing plan, so that manufacturing efficiency can be improved. However, this method makes it difficult to grasp the delivery date for each order or the like. This application enables the planning type to be set at either the procurement-driven type or the manufacturing-driven type based on the switching information on each base and each item in the supply chain so as to ensure the optimum planning by taking advantage of the procurement-driven and the manufacturing-driven.

As explained so far, the present invention adopts a constitution of setting switching information corresponding to each base and each item in a supply chain and doing planning while switching a planning type to an optimum type, i.e., a procurement-driven type or a manufacturing-driven type based on the switching information corresponding to each item at each base. Therefore, it is possible to realize plans for supply and demand, stock, and the like using an optimum method for bases and items.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

### INDUSTRIAL APPLICABILITY

The method of planning, the computer program, and the computer product according to the present invention are suitable for supply-demand planning at a base in a supply chain.

1. A computer program for realizing supply-demand planning in a supply chain, the computer program making a computer execute:
fetching switching information corresponding to a base and an item from a table, which contains the switching information corresponding to the base and the item; and
performing, depending upon the switching information, either of supply-demand planning per order and supply-demand planning based on total amount of orders.

2. The computer program according to claim 1, wherein the performing includes calculating and accumulating all amounts of orders for the item to obtain the total amount of orders.

3. A method of a supply-demand planning in a supply chain, the method comprising:
creating a table containing switching information corresponding to a base and an item;
fetching the switching information corresponding to the base and the item from the table; and
performing, depending upon the switching information, either of supply-demand planning per order and supply-demand planning based on total amount of orders.

4. A computer-readable recording medium for storing a computer program for realizing supply-demand planning in a supply chain, the computer program making a computer execute:
fetching switching information corresponding to a base and an item from a table, which contains the switching information corresponding to the base and the item; and
performing, depending upon the switching information, either of supply-demand planning per order and supply-demand planning based on total amount of orders.

5. A computer program for making supply-demand planning for each base in a supply chain in which a plurality of bases are cascaded, the computer program making a computer execute:
processing a procurement-driven planning in which the supply-demand planning is made for a plurality of bases associated with an order unit;
processing a manufacturing-driven planning in which the supply-demand planning is made based on a total amount of orders for a specific base; and
making the supply-demand planning for the whole supply chain by using either of the procurement-driven planning and the manufacturing-driven planning based on switching information that is managed associated with a combination of a base and an item.
